(19) United States
(12) Patent Application Publication
(10) Pub. No.: US 2022/0220394 A1
(43) Pub. Date: Jul. 14, 2022

(54) OPERATION STATE ESTIMATION SYSTEM, TRAINING DEVICE, ESTIMATION DEVICE, STATE ESTIMATOR GENERATION METHOD, AND ESTIMATION METHOD

(71) Applicant: CHIYODA CORPORATION, Yokohama-shi (JP)

(72) Inventors: Motoki IRIKURA, Kanagawa (JP); Kazuya FURUICHI, Kanagawa (JP); Ryoji OGISO, Kanagawa (JP); Nobuhiro KAKUTA, Kanagawa (JP)

(21) Appl. No.: 17/710,239

(22) Filed: Mar. 31, 2022

Related U.S. Application Data
(63) Continuation of application No. PCT/JP2020/022274, filed on Jun. 5, 2020.

(51) Int. Cl. C10G 11/18; B01J 38/30; G05B 13/02

(52) U.S. Cl. CPC C10G 11/187; C10G 11/182; G05B 13/026; G05B 13/0265; B01J 38/30

(57) ABSTRACT

An operating condition estimation system includes: a learning apparatus that learns a condition estimator for estimating an operating condition of a fluid catalytic cracking apparatus from information that can be acquired while the fluid catalytic cracking apparatus is being operated, the fluid catalytic cracking apparatus including a reaction apparatus in which a catalyst is used and a regeneration apparatus for regenerating the catalyst; and an operating condition estimation apparatus that estimates the operating condition of the fluid catalytic cracking apparatus by using the condition estimator learned by the learning apparatus.

### CROSS REFERENCES TO RELATED APPLICATIONS

This application is a continuation under 35 U.S.C. § 120 of PCT/JP2020/022274, filed Jun. 5, 2020, which hereby claims priority of which and is incorporated herein by reference.

### BACKGROUND OF THE INVENTION

### 1. Field of the Invention

The present invention relates to an operating condition estimation system for estimating the operating condition of an apparatus for producing a petroleum product and to a learning apparatus, estimation apparatus, method of generating a condition estimator, and estimation method applicable to the system.

### 2. Description of the Related Art

An oil refinery for producing a petroleum product by refining crude oil produces a petroleum product by separating the crude oil in a distillation tower into a plurality of fractions having different boiling points and by processing and upgrading the fractions as necessary in a downstream apparatus. For example, heavy fractions or residues (heavy oil) of lower utility value are cracked into high-value fractions such as gasoline by bringing them into contact with a catalyst in fluid state. The catalyst that has been used to produce high-value fractions is regenerated by burning carbon (coke) attached to the surface and returned to the reaction tower for re-use (see, for example, patent literature 1). In this way, crude oil resources can be utilized effectively and the profit of the oil refinery is improved.

### [Patent Literature 1] JP2019-89907

### SUMMARY OF THE INVENTION

Imperfect combustion of coke in a regeneration tower for regenerating a catalyst is known to induce a phenomenon called afterburn (afterburning). When afterburn occurs, the fluid catalytic cracking apparatus may be damaged or may not be able to continue its operation. It is therefore necessary to suppress the occurrence of afterburn.

The invention addresses the above-described issue, and a general purpose thereof is to provide a technology for realizing suitable operation of an oil refinery.

An operating condition estimation system according to an embodiment of the present invention includes: a learning apparatus that learns a condition estimator for estimating, from information that can be acquired while a fluid catalytic cracking apparatus is being operated, an operating condition of the fluid catalytic cracking apparatus, the fluid catalytic cracking apparatus including a reaction apparatus in which a catalyst is used and a regeneration apparatus for regenerating the catalyst; and an estimation apparatus that estimates the operating condition of the fluid catalytic cracking apparatus by using the condition estimator learned by the learning apparatus based on the information acquired while the fluid catalytic cracking apparatus is being operated. The learning apparatus includes: a learning data acquisition unit that acquires, as learning data, the information acquired when the fluid catalytic cracking apparatus was operated in the past; and a learning unit that learns the condition estimator through machine learning, using the learning data acquired by the learning data acquisition unit. The estimation apparatus includes: an operation data acquisition unit that acquires the information acquired while the fluid catalytic cracking apparatus is being operated; an operating condition estimation unit that estimates the operating condition of the fluid catalytic cracking apparatus by inputting the information acquired by the operation data acquisition unit to the condition estimator; and an estimation result output unit that outputs information indicating the operating condition of the fluid catalytic cracking apparatus estimated by the operating condition estimation unit.

Another embodiment of the present invention relates to a learning apparatus. The apparatus includes: a learning data acquisition unit that acquires, as learning data, information acquired when a fluid catalytic cracking apparatus was operated in the past, the fluid catalytic cracking apparatus including a reaction apparatus in which a catalyst is used and a regeneration apparatus for regenerating the catalyst; and a learning unit that learns, through machine learning, a condition estimator for estimating an operating condition of the fluid catalytic cracking apparatus from information that can be acquired while the fluid catalytic cracking apparatus is being operated, by using the learning data acquired by the learning data acquisition unit.

Another embodiment of the present invention relates to an estimation apparatus. The apparatus includes: an operation data acquisition unit that acquires information acquired while a fluid catalytic cracking apparatus is being operated, the fluid catalytic cracking apparatus including a reaction apparatus in which a catalyst is used and a regeneration apparatus for regenerating the catalyst; an operating condition estimation unit that estimates an operating condition of the fluid catalytic cracking apparatus by inputting the information acquired by the operation data acquisition unit to a condition estimator for estimating an operating condition of the fluid catalytic cracking apparatus, the condition estimator being learned through machine learning by a learning apparatus that learns the condition estimator by using, as learning data, the information acquired when the fluid catalytic cracking apparatus was operated in the past; and an estimation result output unit that outputs information indicating the operating condition of the fluid catalytic cracking apparatus estimated by the operating condition estimation unit.

Another embodiment of the present invention relates to a method of generating a condition estimator. The method includes computer-implemented steps of: acquiring, as learning data, information acquired when a fluid catalytic cracking apparatus was operated in the past, the fluid catalytic cracking apparatus including a reaction apparatus in which a catalyst is used and a regeneration apparatus for regenerating the catalyst; and using the learning data acquired to learn, through machine learning, a condition estimator for estimating an operating condition of the fluid catalytic cracking apparatus from information that can be acquired while the fluid catalytic cracking apparatus is being operated.

Another embodiment of the present invention relates to an estimation method. The method includes computer-implemented steps of: acquiring information acquired when a fluid catalytic cracking apparatus is being operated, the fluid catalytic cracking apparatus including a reaction apparatus in which a catalyst is used and a regeneration apparatus for regenerating the catalyst; estimating an operating condition of the fluid catalytic cracking apparatus by inputting the information acquired to a condition estimator for estimating an operating condition of the fluid catalytic cracking apparatus, the condition estimator being learned through machine learning by a learning apparatus that learns the condition estimator by using, as learning data, the information acquired when the fluid catalytic cracking apparatus was operated in the past; and outputting information indicating the operating condition of the fluid catalytic cracking apparatus estimated.

Optional combinations of the aforementioned constituting elements, and implementations of the disclosure in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 schematically shows a configuration of a fluid catalytic cracking apparatus;

FIG. 2 shows a configuration of an operating condition estimation system according to the embodiment;

FIG. 3 shows a relationship between the afterburn indicator and the operating condition of the regeneration apparatus of the fluid catalytic cracking apparatus;

FIG. 4 shows an example of feature amount calculated by the feature amount calculator;

FIG. 5 shows an example of afterburn indicator predicted by the indicator predictor;

FIG. 6 shows an example of afterburn indicator predicted by the indicator predictor;

FIG. 7 shows a configuration of the learning apparatus according to the embodiment;

FIG. 8 shows a configuration of the operating condition estimation apparatus according to the embodiment;

FIG. 9 is a flowchart showing a sequence of steps of a method of generating a condition estimator according to the embodiment; and

FIG. 10 is a flowchart showing a sequence of steps of a method of estimating an operating condition according to the embodiment.

### DETAILED DESCRIPTION OF THE INVENTION

The invention will now be described by reference to the preferred embodiments. This does not intend to limit the scope of the present invention, but to exemplify the invention.

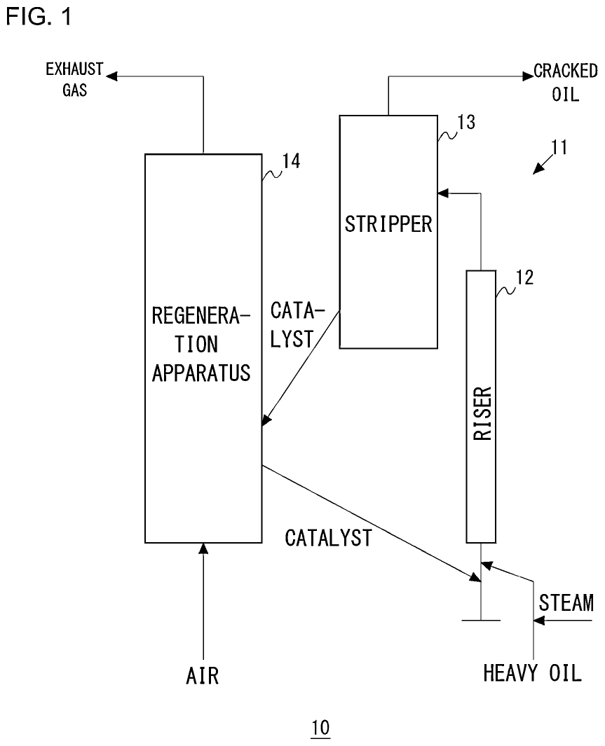

FIG. 1 schematically shows a configuration of a fluid catalytic cracking (FCC) apparatus. The fluid catalytic cracking apparatus 10 includes a reaction apparatus 11 and a regeneration apparatus 14. The reaction apparatus 11 includes a riser 12 and a stripper 13.

The riser 12 is a reaction tower for bringing crude oil into contact with a catalyst to obtain a product. Crude oil, steam, and a catalyst are introduced into the bottom part of the riser 12. The crude oil may be any of a wide range of fraction, residue, etc. ranging from heating oil, light oil, to atmospheric residue having a boiling point higher than that of heating oil (about 170° C.). The catalyst may be particles that include, for example, zeolite, silica, clay mineral, etc. The riser 12 cracks the crude oil under a temperature of, for example, about 500° C. and supplies a cracked product from the top part to the stripper 13.

The stripper 13 introduces a steam into the cracked product supplied from the riser 12 to remove (strip) cracked oil vapor attached to the catalyst and separates only the catalyst downward and supplies the catalyst to the regeneration apparatus 14. The cracked oil extracted from the top part of the stripper 13 is processed and upgraded in a downstream apparatus.

The regeneration apparatus 14 regenerates the catalyst used in the riser 12. When the catalyst is used in a reaction for cracking the crude oil in the riser 12, carbon (coke) is attached to the surface of the catalyst, which deactivates the catalyst. The regeneration apparatus 14 regenerates the coke attached to the surface of the catalyst by burning the coke under a high temperature and supplies the regenerated catalyst to the bottom part of the riser 12. The catalyst with the code attached to the surface and air are introduced into the regeneration apparatus 14. An exhaust gas containing carbon dioxide is discharged from the top part of the regeneration apparatus 14.

A local decrease in the amount of air in the regeneration apparatus 14 induces imperfect combustion of the coke due to shortage of oxygen, which increases the carbon monoxide concentration in the exhaust gas and causes afterburn. When afterburn occurs, the regeneration apparatus 14 may be damaged due to a temperature rise caused by local heat generation, or the fluid catalytic cracking apparatus 10 may not be able to continue its operation. It is therefore important to inhibit the occurrence of afterburn in the regeneration apparatus 14 when the fluid catalytic cracking apparatus 10 is operated.

In the embodiment, the learning apparatus learns, through machine learning, a condition estimator for estimating the operating condition of the fluid catalytic cracking apparatus 10 from the information that can be acquired while the fluid catalytic cracking apparatus 10 is being operated. The operating condition estimation apparatus estimates the operating condition of the fluid catalytic cracking apparatus 10 while the fluid catalytic cracking apparatus 10 is being operated by using the condition estimator that has been learned. More specifically, the learning apparatus learns a feature amount calculator as the condition estimator, the feature amount calculator calculating a feature amount for estimating whether the fluid catalytic cracking apparatus 10 is currently operated in a condition in which afterburn occurs in the regeneration apparatus 14, or in a condition in which afterburn does not occur, or in a condition in which the apparatus is making a transition from a condition in which afterburn does not occur to an operating condition in which afterburn occurs. The operating condition estimation apparatus estimates the current operating condition of the fluid catalytic cracking apparatus 10 based on the feature amount calculated by the feature amount calculator. Further, the learning apparatus learns an indicator predictor as the condition estimator, the indicator predictor predicting the value of an afterburn indicator indicating whether afterburn occurs. The operating condition estimation apparatus estimates a future operating condition of the fluid catalytic cracking apparatus 10 based on the indicator predicted by the indicator predictor. This allows the operation personnel to control the fluid catalytic cracking apparatus 10, knowing the operating condition of the fluid catalytic cracking apparatus 10 properly. Accordingly, the occurrence of afterburn in the regeneration apparatus 14 can be inhibited.

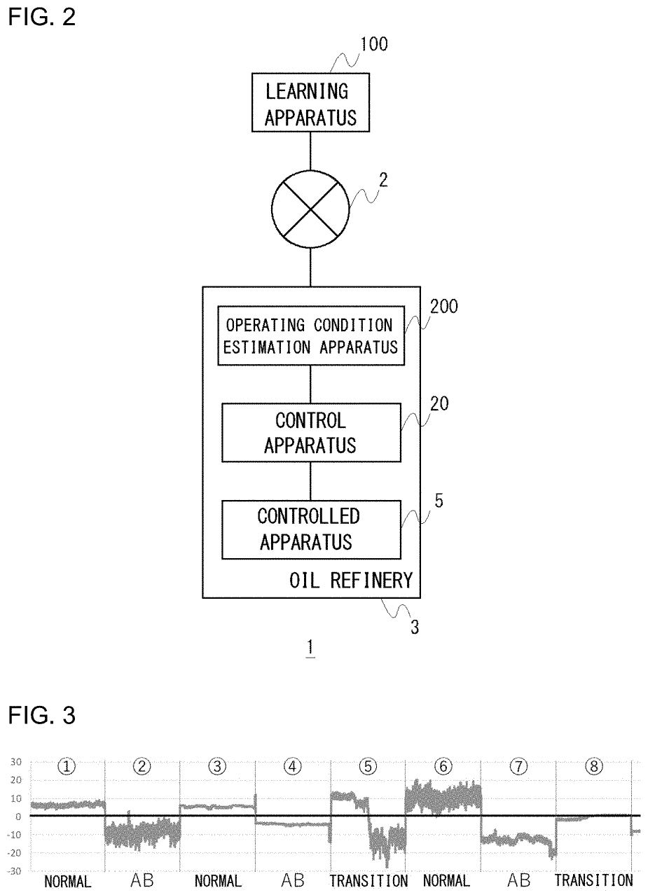

FIG. 2 shows a configuration of an operating condition estimation system according to the embodiment. The operating condition estimation system 1 includes an oil refinery 3 for refining crude oil to produce a petroleum product and a learning apparatus 100 for learning a condition estimator for estimating the operating condition of the fluid catalytic cracking apparatus 10 of the oil refinery 3. The oil refinery 3 and the learning apparatus 100 are connected by an arbitrary communication network 2 such as the Internet and an intra-corporation connection network and are operated in an arbitrary operation mode including on-premises, cloud, and edge computing.

The oil refinery 3 includes: a controlled apparatus 5 installed in the oil refinery 3 such as an atmospheric distillation tower and the fluid catalytic cracking apparatus 10; a control apparatus 20 for setting control variables for controlling the operating condition of the controlled apparatus 5; and an operating condition estimation apparatus 200 for estimating the operating condition of the fluid catalytic cracking apparatus 10 by using the condition estimator learned by the learning apparatus 100.

FIG. 3 shows a relationship between the afterburn indicator and the operating condition of the regeneration apparatus of the fluid catalytic cracking apparatus. The afterburn indicator is selected or calculated to have a positive value when afterburn does not occur in the regeneration apparatus and to have a negative value when afterburn occurs. The positive and negative signs may be inverted. The afterburn indicator may be information that can be acquired from a sensor or an appliance while the fluid catalytic cracking apparatus 10 is being operated or information that is calculated according to a predetermined mathematical expression or calculation algorithm from the information that can be acquired from the sensor or the appliance while the fluid catalytic cracking apparatus 10 is being operated.

The operating conditions of the fluid catalytic cracking apparatus 10 include a normal condition in which the afterburn indicator is positive, an afterburn condition in which the afterburn indicator is negative, and a transition condition in which the afterburn indicator makes a transition from positive to negative or negative to positive.

In period (1), the fluid catalytic cracking apparatus 10 is being normally operated. In period (2), afterburn occurs in the regeneration apparatus 14. The apparatus returns to a normal condition in period (3), but afterburn occurs again in period (4). The apparatus is in a transition condition in period (5) and returns to a normal condition in period (6). Afterburn occurs again in period (7), and the apparatus is in a transition condition in period (8).

The feature amount calculator according to the embodiment calculates, from multi-dimensional information acquired when the fluid catalytic cracking apparatus 10 is operated, a feature amount having a smaller number of dimensions. The learning apparatus 40 learns the feature amount calculator so that the feature amount calculated by the feature amount calculator from the multi-dimensional information is grouped into different clusters depending on the operating condition of the fluid catalytic cracking apparatus 10 occurring when the multi-dimensional information was acquired. The learning apparatus 40 learns the feature amount calculator whereby the feature amount is maintained even if the multi-dimensional information is subject to dimension compression or reduction by a scheme such as an autoencoder used in feature selection or feature extraction, a t distribution stochastic neighbor embedding method, etc.

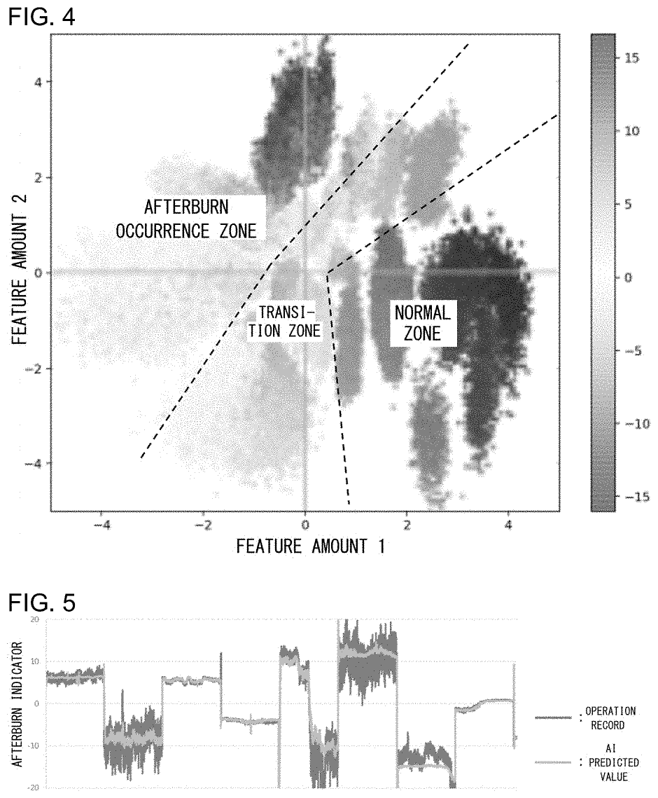

FIG. 4 shows an example of feature amount calculated by the feature amount calculator. The multi-dimensional information acquired when the fluid catalytic cracking apparatus 10 is operated as shown in FIG. 3 is subject to dimension reduction to result in two feature amounts, and the two feature amounts calculated are plotted in a two-dimensional coordinate space. The space is clearly separated into an area where information in periods (1), (3), and (6), in which the apparatus is in a normal condition, is plotted and an area where information in areas (2), (4), and (7), in which the apparatus is in an afterburn condition, is plotted. Further, the areas where information in transition periods (5) and (8) is plotted is located between the area of the normal condition and the area of the afterburn condition. Therefore, the operating condition estimation apparatus 30 can visually present the current operating condition of the fluid catalytic cracking apparatus 10 in an easy-to-understand manner, by using the feature amount calculator learned in this way to calculate the feature amount from the information acquired while the fluid catalytic cracking apparatus 10 is being operated and by plotting the calculated feature amount in the two-dimensional coordinate space shown in FIG. 4. The operation personnel can understand the current operating condition of the fluid catalytic cracking apparatus 10 from the current plot position of the feature amount. The operation personnel can also understand, during a normal condition, the possibility of making a transition to an afterburn condition and understand, during an afterburn condition, the severity thereof.

The information input to the feature amount calculator may be arbitrary information so long as the information can be acquired when the fluid catalytic cracking apparatus 10 is being operated. It is desired that the value of the information differ depending on whether the fluid catalytic cracking apparatus 10 is in an normal operating condition or in an afterburn condition. The information input to the feature amount calculator may be, for example, i) the temperature and temperature distribution inside the regeneration apparatus 14, ii) the temperature and quantity of an exhaust gas discharged from the regeneration apparatus 14, iii) the carbon monoxide concentration and carbon dioxide concentration in the exhaust gas, iv) the temperature, flow volume, flow rate of the fluid flowing in the pipe connected to the regeneration apparatus 14 or the riser 12, v) the position of the valve provided in the pipe, vi) the temperature of the regeneration catalyst supplied from the regeneration apparatus 14 to the riser 12, vii) the amount of coke left, viii) the temperature and quantity of the cracked product supplied from the riser 12 to the stripper 13, and ix) the temperature and quantity of light distillate stripped from the stripper 13.

The feature amount calculator may be learned to learn the information that can be acquired while the fluid catalytic cracking apparatus 10 is being operated by an arbitrary method for class separation or clustering according to the operating condition of the fluid catalytic cracking apparatus 10. The feature amount calculator may be learned with or without a supervisor.

The indicator predictor according to the embodiment calculates a predicted value of the afterburn indicator from the information acquired while the fluid catalytic cracking apparatus 10 is being operated. When the information acquired while the fluid catalytic cracking apparatus 10 was operated at a predetermined point of time in the past is input to the indicator predictor, the learning apparatus 40 learns the indicator predictor so that a predicted value of the afterburn indicator after an elapse of a predetermined period of time since the predetermined point of time is output from the indicator predictor. The indicator predictor may be a neural network that inputs to the input layer the information acquired while the fluid catalytic cracking apparatus 10 is being operated and an estimated value estimated based on the information acquired during the operation and that outputs from the output layer a predicted value of the afterburn indicator after an elapse of a predetermined period of time. In this case, the learning apparatus 40 may adjust various hyper parameters of the neural network so that a predicted value of the afterburn indicator after an elapse of a predetermined period of time since the predetermined point of time is output from the indicator predictor when the information acquired when the fluid catalytic cracking apparatus 10 was operated at the predetermined point of time in the past and the estimated value are input to the indicator predictor.

FIG. 5 shows an example of afterburn indicator predicted by the indicator predictor. The indicator predictor was learned by using, as learning data, the information acquired when the fluid catalytic cracking apparatus 10 is operated as shown in FIG. 3 and the value of the afterburn indicator after 30 minutes. The indicator predictor was learned by using the learning data in the first half of the periods (1)-(8), and the afterburn indicator in the second half of each period was predicted by using the indicator predictor thus learned. It was demonstrated that the afterburn indicator after 30 minutes can be predicted with high precision by the indicator predictor learned in this way. This allows the operation personnel to perform operation management of the fluid catalytic cracking apparatus 10 in real time so that the afterburn indicator does not deviate from a predetermined range, while monitoring the current value and the predicted value of the afterburn indicator.

FIG. 6 shows an example of afterburn indicator predicted by the indicator predictor. The predicted value of the afterburn indicator after 30 minutes predicted by inputting the information acquired when the fluid catalytic cracking apparatus 10 is operated in a period different from the periods shown in FIG. 5 to the indicator predictor learned as described above is compared with the recorded value of the afterburn indicator after 30 minutes. It was shown that the afterburn indicator after 30 minutes can be predicted with high precision by the indicator predictor learned as described above even in the presence of unknown data.

The information input to the indicator predictor may be arbitrary information so long as the information can be acquired while the fluid catalytic cracking apparatus 10 is being operated or so long as the information can be estimated. The information input to the indicator predictor may be selected based on a result of fault tree analysis in which the occurrence of afterburn in the regeneration apparatus 14 is defined as an event above. Further, the weight of a plurality of types of information input to the indicator predictor may be adjusted based on a result of fault tree analysis in which the occurrence of afterburn in the regeneration apparatus 14 is defined as an event above. This makes it possible to learn the indicator predictor to suit the characteristics of the fluid catalytic cracking apparatus 10 or peripheral apparatuses so that the precision of the indicator predictor can be improved.

The information input to the feature amount calculator may be, for example, i) the temperature and temperature distribution inside the regeneration apparatus 14, ii) the temperature and quantity of an exhaust gas discharged from the regeneration apparatus 14, iii) the carbon monoxide concentration and carbon dioxide concentration in the exhaust gas, iv) the temperature, flow volume, flow rate of the fluid flowing in the pipe connected to the regeneration apparatus 14 or the riser 12, v) the position of the valve provided in the pipe, vi) the temperature and quantity of an exhaust gas discharged from the regeneration apparatus 14, vii) the carbon monoxide concentration and carbon dioxide concentration in the exhaust gas, viii) the temperature of the regeneration catalyst supplied from the regeneration apparatus 14 to the riser 12, ix) the amount of coke left, x) the temperature and quantity of the cracked product supplied from the riser 12 to the stripper 13, and xi) the temperature and quantity of light distillate stripped from the stripper 13.

The learning apparatus 40 may adjust, based on a difference between a) the predicted value of the afterburn indicator calculated by the indicator predictor learned by using, as learning data, particular information of a plurality of types of information acquired while the fluid catalytic cracking apparatus 10 is being operated and b) the predicted value of the afterburn indicator calculated by the indicator calculator learned without using the information as learning data, the weight of the information. Because it is considered that the larger the difference, the larger the contribution to the afterburn indicator, the weight of the information may be increased. This further improves the precision of the indicator predictor.

The operating condition estimation apparatus 30 may present to the operation personnel the predicted value of the afterburn indicator calculated by the indicator predictor learned by using the particular information as learning data and the predicted value of the afterburn indicator calculated by the indicator calculator learned without using the particular information as learning data. This makes it possible for the operation personnel to judge whether the particular information causes afterburn so that the operation personnel can perform proper control for avoiding the occurrence of afterburn.

The learning apparatus 40 may generate learning data by adjusting the plurality of types of information acquired while the fluid catalytic cracking apparatus 10 is being operated according to an offset time that depends on the type of information. In this case, the operating condition estimation apparatus 30 adjusts the plurality of types of information acquired while the fluid catalytic cracking apparatus 10 is being operated according to the offset time that depends on the type of information before inputting the information to the indicator predictor. For example, the flow volume of the fluid flowing in the pipe changes immediately when the position of the valve provided in the pipe is changed. It takes time, however, for the impact of local temperature change inside the regeneration apparatus 14 to be propagated around when afterburn occurs inside the regeneration apparatus 14. By adjusting the offset time in consideration of such a response characteristic, the precision of the indicator predictor can be further improved.

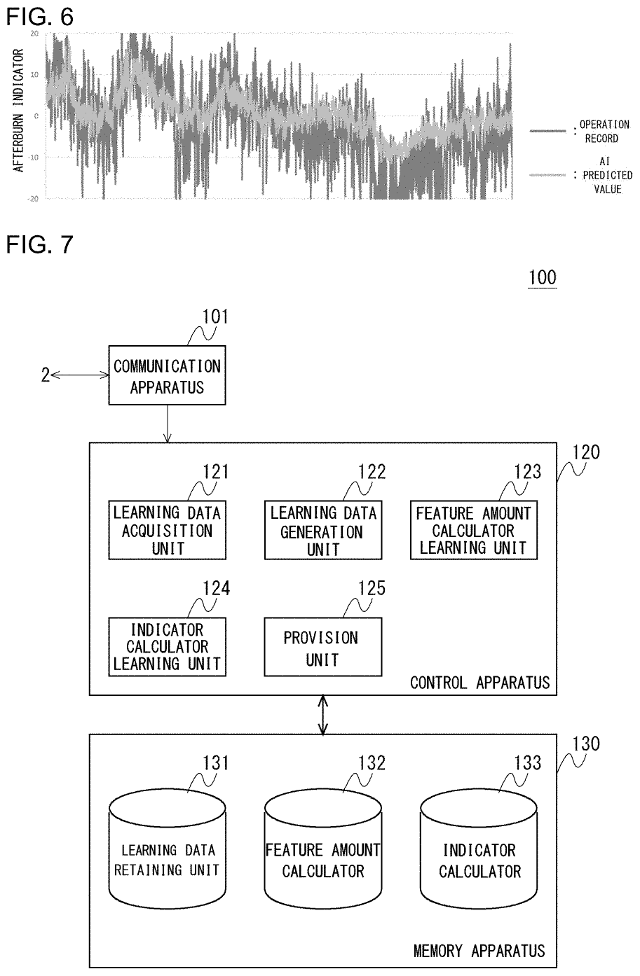

FIG. 7 shows a configuration of the learning apparatus 100 according to the embodiment. The learning apparatus 100 includes a communication apparatus 101, a control apparatus 120, and a memory apparatus 130.

The communication apparatus 101 controls wireless or wired communication. The communication apparatus 101 exchanges data with the operating condition estimation apparatus 200, etc. via the communication network 2.

The memory apparatus 130 stores data and a computer program used by the control apparatus 120. The memory apparatus 130 includes a learning data retaining unit 131, a feature amount calculator 132, and an indicator calculator 133.

The learning data retaining unit 131 stores, as learning data, information acquired while the fluid catalytic cracking apparatus 10 is being operated. The feature amount calculator 132 and the indicator calculator 133 are learned by the learning apparatus 100.

The control apparatus 120 includes a learning data acquisition unit 121, a learning data generation unit 122, a feature amount calculator learning unit 123, an indicator calculator learning unit 124, and a provision unit 125. The features are implemented in hardware components such as a CPU, a memory, a program loaded into the memory, etc. of an arbitrary computer. The figure depicts functional blocks implemented by the cooperation of these elements. Therefore, it will be understood by those skilled in the art that the functional blocks may be implemented in a variety of manners by hardware only, software only, or by a combination of hardware and software.

The learning data acquisition unit 121 acquires information that can be acquired while the fluid catalytic cracking apparatus 10 is being operated from various sensors, appliances, apparatuses, facilities, the fluid catalytic cracking apparatus 10, the control apparatus 20, etc. provided in the oil refinery 3 and stores the information in the learning data retaining unit 131.

The learning data generation unit 122 generates learning data for learning the feature amount calculator 132 and the indicator calculator 133 from the information stored in the learning data retaining unit 131. As described above, the learning data generation unit 122 may select learning data from the information stored in the learning data retaining unit 131, based on a result of fault tree analysis in which the occurrence of afterburn in the regeneration apparatus 14 is defined as an event above. The learning data generation unit 122 may generate learning data by subjecting the information stored in the learning data retaining unit 131 to a preprocess such as adjustment of the offset time depending on the type of information. The learning data generation unit 122 may generate learning data by calculating or estimating further information from the information stored in the learning data retaining unit 131.

The feature amount calculator learning unit 123 learns the feature amount calculator 132 by using the learning data generated by the learning data generation unit 122. As described above, the feature amount calculator learning unit 123 learns the feature amount calculator 132 whereby the feature of the operating condition of the fluid catalytic cracking apparatus 10 maintained in a feature amount having a smaller number of dimensions, even if the multi-dimensional learning data is subject to dimension compression or reduction by a scheme such as an autoencoder, a t distribution stochastic neighbor embedding method, etc.

The indicator calculator learning unit 124 learns the indicator calculator 133 by using learning data generated by the learning data generation unit 122. As described above, the indicator calculator learning unit 124 learns the indicator calculator 133 that receives a plurality of items of learning data and outputs a predicted value of the afterburn indicator after an elapse of a predetermined period of time.

The provision unit 125 provides the feature amount calculator 132 learned by the feature amount calculator learning unit 123 and the indicator calculator 133 learned by the indicator calculator learning unit 124 to the operating condition estimation apparatus 200.

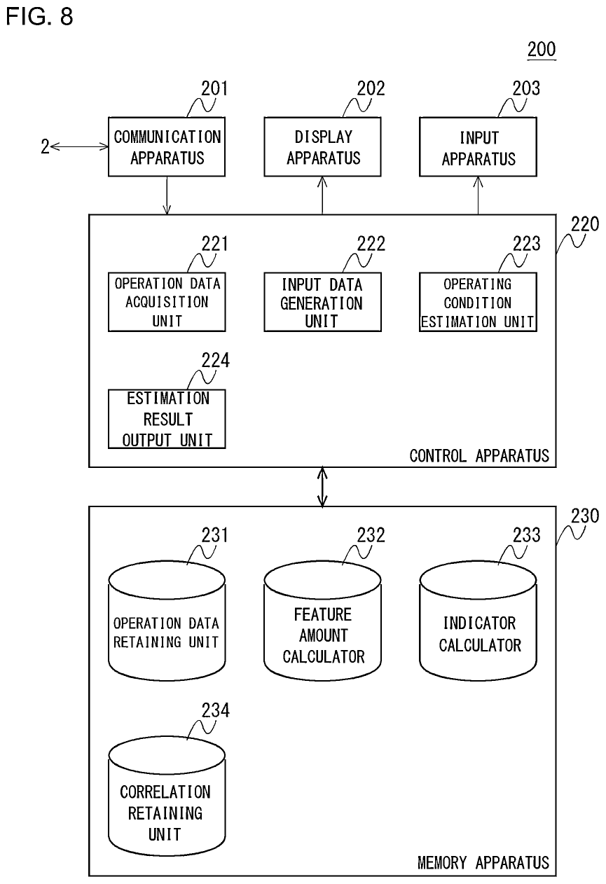

FIG. 8 shows a configuration of the operating condition estimation apparatus 200 according to the embodiment. The operating condition estimation apparatus 200 includes a communication apparatus 201, a display apparatus 202, an input apparatus 203, a control apparatus 220, and a memory apparatus 230.

The communication apparatus 201 controls wireless or wired communication. The communication apparatus 201 exchanges data with the learning apparatus 100, etc. via the communication network 2. The display apparatus 202 displays a display image generated by the control apparatus 220. The input apparatus 203 inputs an instruction to the control apparatus 220.

The memory apparatus 230 stores data and a computer program used by the control apparatus 220. The memory apparatus 230 includes an operation data retaining unit 231, a feature amount calculator 232, an indicator calculator 233, and a correlation retaining unit 234.

The operation data retaining unit 231 stores information acquired while the fluid catalytic cracking apparatus 10 is being operated. The feature amount calculator 232 and the indicator calculator 233 are learned by the learning apparatus 100 and provided by the learning apparatus 100. The correlation retaining unit 234 retains the correlation between the coordinates of the feature amount output from the feature amount calculator 232 in a two-dimensional coordinate space or a three-dimensional coordinate space and the operating condition of the fluid catalytic cracking apparatus 10.

The control apparatus 220 includes an operation data acquisition unit 221, an input data generation unit 222, an operating condition estimation unit 223, and an estimation result output unit 224. These features can be implemented in various forms, using hardware only, software only, or a combination thereof.

The operation data acquisition unit 221 acquires information that can be acquired while the fluid catalytic cracking apparatus 10 is being operated from various sensors, appliances, apparatuses, facilities, the fluid catalytic cracking apparatus 10, the control apparatus 20, etc. provided in the oil refinery 3 and stores the information in the learning data retaining unit 131.

The input data generation unit 222 generates input data input to the feature amount calculator 232 and the indicator calculator 233, from the information stored in the operation data retaining unit 231. The input data generation unit 222 may subject the information stored in the operation data retaining unit 231 to the same preprocess performed in the learning apparatus 100 by the learning data generation unit 122 to generate learning data.

The operating condition estimation unit 223 inputs the input data generated by the input data generation unit 222 to the feature amount calculator 232 and the indicator calculator 233 and acquires estimation results from each.

The estimation result output unit 224 outputs the estimation result acquired by the operating condition estimation unit 223. The estimation result output unit 224 displays a chart showing the feature amount calculated by the feature amount calculator 232 plotted in a two-dimensional coordinate space or a three-dimensional coordinate space on the display apparatus 202. The estimation result output unit 224 may refer to the correlation stored in the correlation retaining unit 234 and further display the operating condition of the fluid catalytic cracking apparatus 10 corresponding to the feature amount calculated by the feature amount calculator 232 on the display apparatus 202. The estimation result output unit 224 displays the predicted value of the afterburn indicator calculated by the indicator calculator 233 on the display apparatus 202.

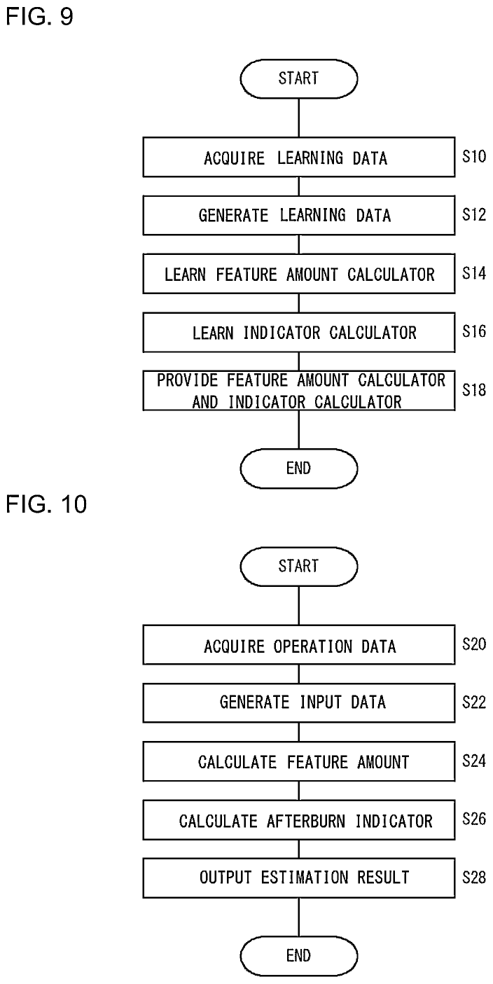

FIG. 9 is a flowchart showing a sequence of steps of a method of generating a condition estimator according to the embodiment. The learning data acquisition unit 121 of the learning apparatus 100 acquires information that can be acquired while the fluid catalytic cracking apparatus 10 is being operated (S10). The learning data generation unit 122 generates learning data for learning the feature amount calculator 132 and the indicator calculator 133, from the information acquired by the learning data acquisition unit 121 (S12). The feature amount calculator learning unit 123 learns the feature amount calculator 132 by using the learning data generated by the learning data generation unit 122 (S14). The indicator calculator learning unit 124 learns the indicator calculator 133 by using the learning data generated by the learning data generation unit 122 (S16). The provision unit 125 provides the feature amount calculator 132 learned by the feature amount calculator learning unit 123 and the indicator calculator 133 learned by the indicator calculator learning unit 124 to the operating condition estimation apparatus 200 (S18).

FIG. 10 is a flowchart showing a sequence of steps of a method of estimating an operating condition according to the embodiment. The operation data acquisition unit 221 of the operating condition estimation apparatus 200 acquires information that can be acquired while the fluid catalytic cracking apparatus 10 is being operated (S20). The input data generation unit 222 generates input data input to the feature amount calculator 232 and the indicator calculator 233, from the information acquired by the operation data acquisition unit 221 (S22). The operating condition estimation unit 223 inputs the input data generated by the input data generation unit 222 to the feature amount calculator 232 to calculate the feature amount (S24). The operating condition estimation unit 223 inputs the input data generated by the input data generation unit 222 to the indicator calculator 233 to calculate the afterburn indicator (S26). The estimation result output unit 224 outputs the estimation result acquired by the operating condition estimation unit 223 (S28).

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. An operating condition estimation system comprising:
a learning apparatus that learns a condition estimator for estimating, from information that can be acquired while a fluid catalytic cracking apparatus is being operated, an operating condition of the fluid catalytic cracking apparatus, the fluid catalytic cracking apparatus including a reaction apparatus in which a catalyst is used and a regeneration apparatus for regenerating the catalyst; and
an estimation apparatus that estimates the operating condition of the fluid catalytic cracking apparatus by using the condition estimator learned by the learning apparatus based on the information acquired while the fluid catalytic cracking apparatus is being operated, wherein
the learning apparatus includes:
a learning data acquisition unit that acquires, as learning data, the information acquired when the fluid catalytic cracking apparatus was operated in the past; and
a learning unit that learns the condition estimator through machine learning, using the learning data acquired by the learning data acquisition unit, and
the estimation apparatus includes:
an operation data acquisition unit that acquires the information acquired while the fluid catalytic cracking apparatus is being operated;
an operating condition estimation unit that estimates the operating condition of the fluid catalytic cracking apparatus by inputting the information acquired by the operation data acquisition unit to the condition estimator; and
an estimation result output unit that outputs information indicating the operating condition of the fluid catalytic cracking apparatus estimated by the operating condition estimation unit.

2. The operating condition estimation system according to claim 1,
the operating condition includes at least two of a condition in which afterburn does not occur in the regeneration apparatus, a condition in which afterburn occurs in the regeneration apparatus, and a condition in which the regeneration apparatus is making a transition from a condition in which afterburn does not occur to a condition in which afterburn occurs.

3. The operating condition estimation system according to claim 1, wherein
the condition estimator calculates a feature amount having a smaller number of dimensions than the information acquired by the learning data acquisition unit.

4. The operating condition estimation system according to claim 3, wherein
the learning unit learns the condition estimator so that the feature amount calculated by the condition estimator from the learning data is grouped into different clusters depending on the operating condition of the fluid catalytic cracking apparatus occurring when the learning data is acquired.

5. The operating condition estimation system according to claim 3, wherein
the feature amount is two-dimensional or three-dimensional, and
the estimation result output unit outputs a chart showing the feature amount plotted in a two-dimensional coordinate space or a three-dimensional coordinate space.

6. The operating condition estimation system according to claim 5, wherein
the estimation result output unit retains a correlation between coordinates of the feature amount in a two-dimensional coordinate space or a three-dimensional coordinate space and the operating condition of the fluid catalytic cracking apparatus and further outputs the operating condition of the fluid catalytic cracking apparatus corresponding to the feature amount calculated by the condition estimator.

7. The operating condition estimation system according to claim 1, wherein
when the information acquired when the fluid catalytic cracking apparatus was operated at a predetermined point of time in the past is input to the condition estimator, the learning unit learns the condition estimator so that a predicted value of a different type of information acquired after an elapse of a predetermined period of time since the predetermined point of time is output from the condition estimator.

8. The operating condition estimation system according to claim 7, wherein
the learning unit adjusts a weight of each of a plurality of types of information acquired by the learning data acquisition unit from which information the condition estimator calculates the predicted value, based on a result of fault tree analysis in which an occurrence of afterburn in the regeneration apparatus is defined as an event above.

9. The operating condition estimation system according to claim 8, wherein
the learning unit adjusts, based on a difference between a) the predicted value calculated by the condition estimator learned by using, as learning data, particular information of the plurality of types of information acquired by the learning data acquisition unit and b) the predicted value calculated by the condition estimator learned without using the particular information as learning data, the weight of the particular information.

10. The operating condition estimation system according to claim 9, wherein
the estimation result output unit outputs the predicted value calculated by the condition estimator learned by using the particular information as learning data and the predicted value calculated by the condition estimator learned without using the particular information as learning data.

11. The operating condition estimation system according to claim 1, wherein
the learning apparatus further includes a learning data generation unit that generates learning data by adjusting a plurality of types of information acquired by the learning data acquisition unit according to an offset time that depends on the type of information, and
the estimation apparatus further includes an input data generation unit that generates input data input to the condition estimator by adjusting a plurality of types of information acquired by the operation data acquisition unit according to the offset time that depends on the type of information.

12. The operating condition according to claim 11, wherein
the plurality of types of information include information indicating a temperature in the regeneration apparatus at a predetermined point of time and information indicating an operating condition of the reaction apparatus or the regeneration apparatus at a point of time before the predetermined point of time.

13. The operating condition estimation system according to claim 1, wherein
the reaction apparatus processes a fluid having a boiling point equal to or higher than 170° C.

14. A learning apparatus comprising:
a learning data acquisition unit that acquires, as learning data, information acquired when a fluid catalytic cracking apparatus was operated in the past, the fluid catalytic cracking apparatus including a reaction apparatus in which a catalyst is used and a regeneration apparatus for regenerating the catalyst; and
a learning unit that learns, through machine learning, a condition estimator for estimating an operating condition of the fluid catalytic cracking apparatus from information that can be acquired while the fluid catalytic cracking apparatus is being operated, by using the learning data acquired by the learning data acquisition unit.

15. An estimation apparatus comprising:
an operation data acquisition unit that acquires information acquired while a fluid catalytic cracking apparatus is being operated, the fluid catalytic cracking apparatus including a reaction apparatus in which a catalyst is used and a regeneration apparatus for regenerating the catalyst;
an operating condition estimation unit that estimates an operating condition of the fluid catalytic cracking apparatus by inputting the information acquired by the operation data acquisition unit to a condition estimator for estimating an operating condition of the fluid catalytic cracking apparatus, the condition estimator being learned through machine learning by a learning apparatus that learns the condition estimator by using, as learning data, the information acquired when the fluid catalytic cracking apparatus was operated in the past; and
an estimation result output unit that outputs information indicating the operating condition of the fluid catalytic cracking apparatus estimated by the operating condition estimation unit.

16. A computer-implemented method of generating a condition estimator, comprising:
acquiring, as learning data, information acquired when a fluid catalytic cracking apparatus was operated in the past, the fluid catalytic cracking apparatus including a reaction apparatus in which a catalyst is used and a regeneration apparatus for regenerating the catalyst; and
using the learning data acquired to learn, through machine learning, a condition estimator for estimating an operating condition of the fluid catalytic cracking apparatus from information that can be acquired while the fluid catalytic cracking apparatus is being operated.

17. A estimation method comprising:
acquiring information acquired when a fluid catalytic cracking apparatus is being operated, the fluid catalytic cracking apparatus including a reaction apparatus in which a catalyst is used and a regeneration apparatus for regenerating the catalyst;
estimating an operating condition of the fluid catalytic cracking apparatus by inputting the information acquired to a condition estimator for estimating an operating condition of the fluid catalytic cracking apparatus, the condition estimator being learned through machine learning by a learning apparatus that learns the condition estimator by using, as learning data, the information acquired when the fluid catalytic cracking apparatus was operated in the past; and
outputting information indicating the operating condition of the fluid catalytic cracking apparatus estimated.
